(19) United States
(12) Patent Application Publication
(10) Pub. No.: US 2025/0354669 A1
(43) Pub. Date: Nov. 20, 2025

(54) TREE LAMP

(71) Applicant: Fangfang Lin, Zhejiang Province (CN)

(72) Inventor: Fangfang Lin, Zhejiang Province (CN)

(21) Appl. No.: 18/779,502

(22) Filed: Jul. 22, 2024

Related U.S. Application Data
(63) Continuation-in-part of application No. 18/667,507, filed on May 17, 2024.

(51) Int. Cl. F21S 9/02; F21V 19/00; F21V 23/04

(52) U.S. Cl. CPC F21S 9/02; F21V 19/0005; F21V 23/04

(57) ABSTRACT

Provided in the present application is a tree lamp. The tree lamp includes a lamp housing and a base, where the lamp housing is configured to have a tree shape, and a lower end of the lamp housing is provided with a mounting portion; a top surface of the base is provided with a mounting recess fitted with the mounting portion, and the mounting portion is detachably mounted in the mounting recess; and the mounting portion and/or the mounting recess are/is provided with limiting structures, and when the mounting portion is mounted in the mounting recess, the limiting structures abut against the mounting portion or the mounting recess so as to limit rotation of the mounting portion relative to the mounting recess in at least one direction.

### CROSS REFERENCE TO RELATED APPLICATION

This application is a continuation in part of U.S. application Ser. No. 18/667,507, entitled “DECORATIVE TREE LAMP,” filed May 17, 2024, and the entire contents of which are incorporated herein by reference.

### TECHNICAL FIELD

The present application relates to the field of lamps, in particular to a tree lamp.

### BACKGROUND

A tree lamp, as a decorative lamp simulating the shape of a tree, can provide illumination and also have a high ornamental value. Thus, the tree lamp can be widely applied in various places such as squares, courtyards, hotel lobbies, living rooms or bedrooms.

The tree lamp in the related technologies includes an upper tree-shaped lamp housing and a bottom base, the lamp housing is usually mounted on the base by means of bolts in a connected manner, when a joint of the lamp housing and the base is slightly loose, the lamp housing may rotate or shake with an axis of a lamp holder as an axis, resulting in random change of the angle of the lamp housing, which is adverse to normal use of the product, and thus the reliability of the product is poor.

### SUMMARY

On this basis, it is necessary to provide a tree lamp to solve at least one of the above problems.

The present application provides a tree lamp, comprising:
a lamp housing, where the lamp housing is configured to have a tree shape, and a lower end of the lamp housing is provided with a mounting portion; and
a base, where a top surface of the base is provided with a mounting recess fitted with the mounting portion, and the mounting portion is detachably mounted in the mounting recess;
and

the mounting portion and/or the mounting recess are/is provided with limiting structures, and when the mounting portion is mounted in the mounting recess, the limiting structures abut against the mounting portion or the mounting recess so as to limit rotation of the mounting portion relative to the mounting recess in at least one direction.

Optionally, the mounting portion is of a columnar structure, the mounting recess is a round recess, and the mounting portion is capable of being connected to the base in a manner of rotating relative to the mounting recess.

Optionally, the limiting structures comprise first protrusions and a second protrusion, the first protrusions are formed on an outer wall of the mounting portion and extend in a circumferential direction of the mounting portion, and the second protrusion is formed on an inner wall of the mounting recess and extends in an axial direction of the mounting recess; and
when the mounting portion is inserted into the mounting recess and rotated to a preset angle, a side edge of one of the first protrusions abuts against a side edge of the second protrusion.

Optionally, the mounting recess is further provided with third protrusions, and the third protrusions extend in a circumferential direction of the mounting recess and are higher than the second protrusion; and
when the mounting portion is inserted into the mounting recess and rotated to the preset angle, upper edges of the first protrusions abut against lower edges of the third protrusions.

Optionally, there are a plurality of third protrusions, the plurality of third protrusions are provided at intervals in the circumferential direction of the mounting recess, the number of the first protrusions is equal to the number of the third protrusions, and positions of the first protrusions are fitted with positions of the third protrusions.

Optionally, there are three or four third protrusions, and the plurality of third protrusions are distributed uniformly in the circumferential direction of the mounting recess. Optionally, there is one second protrusion.

Optionally, the limiting structures comprise first protrusions and limiting grooves, the first protrusions are formed on a side wall of the mounting portion and extend in an axial direction of the mounting portion, the limiting grooves are L-shaped grooves and are formed in an inner wall of the mounting recess, and each of the limiting grooves comprises a first groove extending in an axial direction of the mounting recess and a second groove extending in a circumferential direction of the mounting recess; and
in a process of mounting the lamp housing on the base, when the first protrusions are inserted into the first grooves through openings of the first grooves, then enter the second grooves and are rotated to a preset angle in the circumferential direction, side edges of the first protrusions abut against side walls of the second grooves.

Optionally, there are two limiting grooves and two first protrusions, the two limiting grooves are distributed uniformly in the circumferential direction of the mounting recess, the two first protrusions are distributed uniformly in a circumferential direction of the mounting portion, and positions of the first protrusions are fitted with positions of the limiting grooves.

Optionally, an accommodating cavity is provided inside the lamp housing; the tree lamp further comprises a light-emitting body provided in the accommodating cavity; and a power supply unit for supplying power to the light-emitting body is provided inside the base.

Optionally, the mounting portion is provided with a power connection contact electrically connected to the light-emitting body, the mounting recess is provided with an electrically-conductive structure electrically connected to the power supply unit, and when the mounting portion is mounted in the mounting recess, the power connection contact is in contact with the electrically-conductive structure.

Optionally, the power connection contact is provided inside the mounting portion, the bottom of the mounting portion is provided with a first through hole for exposing the power connection contact, and there is one power connection contact that is located at the center of the mounting portion; and
the electrically-conductive structure is an electrically-conductive column provided at the center of the mounting recess, and one end of the electrically-conductive column close to the power connection contact is provided with an insertion hole allowing the power connection contact to be inserted in.

Optionally, the power connection contacts are provided at the bottom of the mounting portion, there are two power connection contacts, and distances between the two power connection contacts and the center of the mounting portion are not equal;
the electrically-conductive structure is located on a bottom wall of the mounting recess, the electrically-conductive structure comprises a first electrically-conductive sheet and a second electrically-conductive sheet, and the first electrically-conductive sheet and the second electrically-conductive sheet are configured to be in contact with the different power connection contacts; and the first electrically-conductive sheet is a round electrically-conductive sheet, the second electrically-conductive sheet is an annular electrically-conductive sheet and surrounds the first electrically-conductive sheet, and there is a gap between the first electrically-conductive sheet and the second electrically-conductive sheet.

Optionally, one of the two power connection contacts is located at the center of the mounting portion, and the other one deviates from the center of the mounting portion, or
the two power connection contacts deviate from the center of the mounting portion.

Optionally, the lamp housing comprises a housing body, the mounting portion is detachably connected to a lower end of the housing body, the accommodating cavity is located inside the housing body, the mounting portion is of a sleeve structure, the power connection contact is provided on the sleeve structure, the lower end of the housing body is of a hollow cylindrical structure, and the sleeve structure is detachably sleeved on an inner wall or an outer wall of the cylindrical structure.

Optionally, the sleeve structure is in threaded connection with the cylindrical structure, an internal thread is formed on an inner wall of the sleeve structure, and an external thread fitted with the internal thread is formed on the outer wall of the cylindrical structure.

Optionally, the sleeve structure is provided with a snap-fitting block, at least a part of the snap-fitting block protrudes out of an outer wall of the sleeve structure, the inner wall of the cylindrical structure is provided with a snap-fitting groove fitted with the snap-fitting block, the sleeve structure is sleeved on the inner wall of the cylindrical structure, and the snap-fitting block is embedded in the snap-fitting groove.

Optionally, the power supply unit comprises a battery and a circuit board, and the electrically-conductive structure and the battery are electrically connected to the circuit board.

Optionally, the tree lamp further comprises a control switch, where the control switch is electrically connected to the circuit board.

Optionally, the base comprises an upper housing and a lower cover plate, the lower cover plate is detachably connected to the upper housing, the upper housing and the lower cover plate enclose a mounting cavity, and the power supply unit is located in the mounting cavity.

It can be seen from the above technical solutions that the embodiments of the present application at least have the following advantages and positive effects:

according to the tree lamp in the embodiments of the present application, the mounting portion and/or the mounting recess are/is provided with the limiting structures, so that when the lamp housing is mounted on the base, the limiting structures abut against the mounting portion or the mounting recess so as to limit the rotation of the mounting portion relative to the base in the at least one direction, rotation or shaking of the lamp housing relative to the base can be limited, and an illumination effect is prevented from being affected by the instability of the lamp housing or change of an angle of the lamp housing.

### BRIEF DESCRIPTION OF DRAWINGS

The accompanying drawings are only used for illustrative description and cannot be understood as limitations on the present patent. The same reference numerals are used for members with the same structures and the same functions. In the drawings:

FIG. 1 is an overall structural schematic diagram of a tree lamp in an embodiment of the present application;

FIG. 2 is a state diagram of a lamp housing of the tree lamp as shown in FIG. 1 detached from a base;

FIG. 3 is an overall structural schematic diagram of a lamp housing in an embodiment of the present application;

FIG. 4 is a partial enlarged view of a mounting portion in area A of the lamp housing as shown in FIG. 3;

FIG. 5 is an overall structural schematic diagram of a base in the embodiment as shown in FIG. 3;

FIG. 6 is a partial enlarged view of a mounting recess in area B of the base as shown in FIG. 5;

FIG. 7 is an overall structural schematic diagram of a lamp housing in another embodiment of the present application;

FIG. 8 is a partial enlarged view of a mounting portion in area C of the lamp housing as shown in FIG. 7;

FIG. 9 is an overall structural schematic diagram of a base in the embodiment as shown in FIG. 7;

FIG. 10 is a partial enlarged view of a mounting recess in area D of the base as shown in FIG. 9;

FIG. 11 is an exploded structural schematic diagram of the lamp housing in the embodiment as shown in FIG. 3;

FIG. 12 is an exploded structural schematic diagram of the lamp housing in the embodiment as shown in FIG. 7;

FIG. 13 is an exploded structural schematic diagram of a lamp housing in an embodiment of the present application;

FIG. 14 is a schematic diagram of electrical connection in an embodiment of the present application; and

FIG. 15 is a structural schematic diagram of a base in an embodiment of the present application.

### DESCRIPTION OF REFERENCE NUMERALS

10. tree lamp;
100. lamp housing; 101. housing body; 101a. first housing body; 101b. second housing body; 101c. cylindrical structure; 110. mounting portion; 111. power connection contact; 112. first through hole; 113. sleeve structure; 120. accommodating cavity; 130. simulated branch;
200. base; 210. mounting recess; 211. electrically-conductive structure; 2111. electrically-conductive column; 2111a. insertion hole; 2112. first electrically-conductive sheet; 2113. second electrically-conductive sheet; 220. power supply unit; 221. battery; 222. circuit board; 230. upper housing; 240. lower cover plate;
300. limiting structure; 310. first protrusion; 320; second protrusion; 330. third protrusion; 340. limiting groove; 341. first groove; 342. second groove;
400. light-emitting body;
500. control switch; and
600. wire.

### DETAILED DESCRIPTION OF THE EMBODIMENTS

The technical solutions in embodiments of the present application will be described below in conjunction with the accompanying drawings in the embodiments of the present application. In the description of the embodiments of the present application, unless otherwise specified, “/” indicates the meaning of “or”, for example, A/B may indicate A or B; and the term “and/or” herein is only intended to describe association relationships of associated objects, and indicates that there may be three relationships, for example, the expression of “A and/or B” may indicate the following three conditions: A exists separately, A and B exist at the same time, and B exists separately. In addition, in the description of the embodiments of the present application, “a plurality of” means two or more.

Hereinafter, the terms “first” and “second” are only for the purpose of describing, and cannot be understood as indicating or implying the relative importance or implicitly indicating the number of technical features indicated. Thus, the features defined as “first” and “second” may explicitly or implicitly include one or more such features.

As mentioned in the background, the tree lamp in the related technologies includes the upper lamp housing and the bottom base, the lamp housing is mounted on the base in a detachably connected manner, and when the joint of the lamp housing and the base is prone to loosening, the lamp housing may rotate or shake with the axis of the base as the axis. Thus, the angle of the lamp housing is changed at random, which is adverse to normal use of the product, and the reliability is low.

On this basis, an embodiment of the present application provides a tree lamp 10, so as to avoid or reduce rotation and shaking of a lamp housing 100 mounted on a base 200.

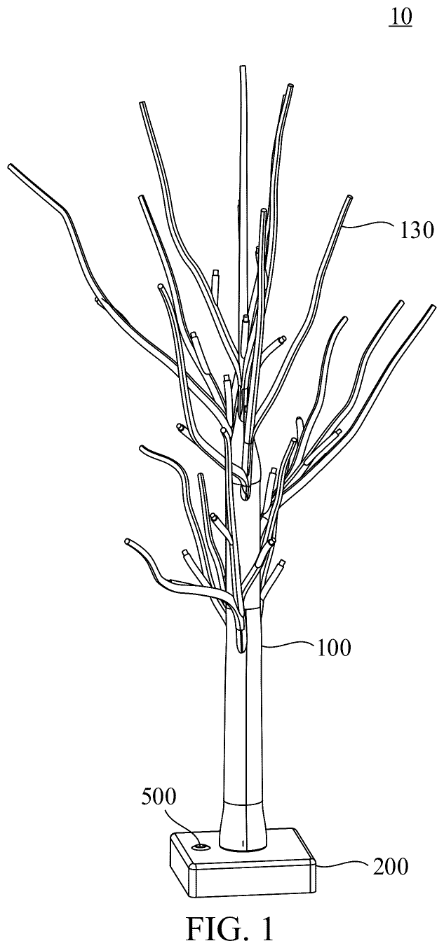

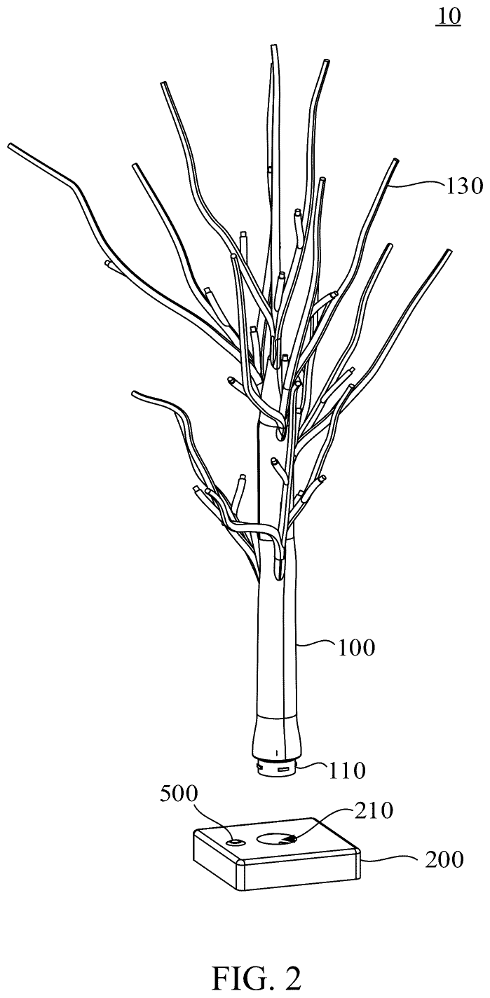

Reference is made to FIG. 1 and FIG. 2, and the embodiment of the present application provides the tree lamp 10. The tree lamp 10 includes the lamp housing 100 and the base 200, where the lamp housing 100 is configured to have a tree shape, so that the lamp housing 100 can play a role in decoration. A lower end of the lamp housing 100 is provided with a mounting portion 110, a top surface of the base 200 is provided with a mounting recess 210 fitted with the mounting portion 110, and the mounting portion 110 is detachably mounted in the mounting recess 210, so that the lamp housing 100 can be detachably mounted on the base 200, thereby facilitating storage, carrying and separate maintenance.

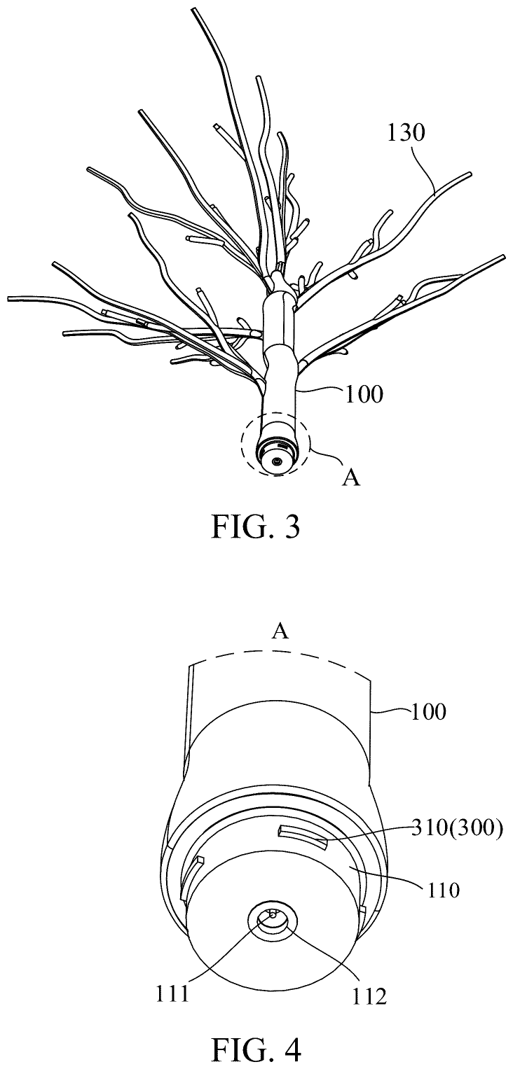

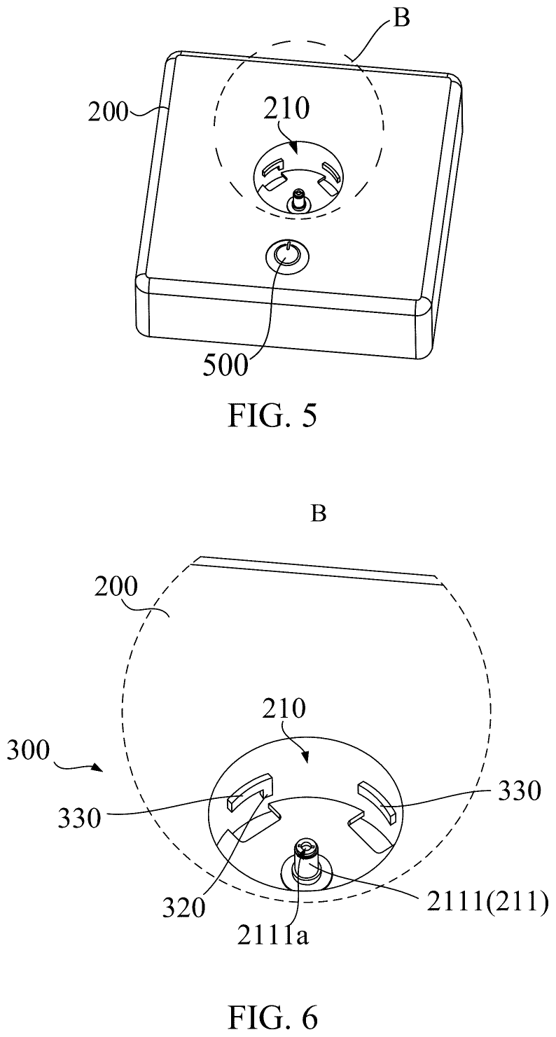

Reference is made to FIG. 3, FIG. 4, FIG. 5 and FIG. 6, the mounting portion 110 and/or the mounting recess 210 are/is provided with limiting structures 300, and when the mounting portion 110 is mounted in the mounting recess 210, the limiting structures 300 abut against the mounting portion 110 or the mounting recess 210 so as to limit rotation of the mounting portion 110 relative to the mounting recess 210 in at least one direction.

Specifically, the mounting portion 110 is of a columnar structure, the mounting recess 210 is a round recess, and the mounting portion 110 is capable of being connected to the base 200 in a manner of rotating relative to the mounting recess 210. It is understandable that in other embodiments, the mounting portion 110 can be provided on the base 200, and the mounting recess 210 fitted with the mounting portion 110 can be provided in the lamp housing 100, that is, the position of the mounting portion 110 and the position of the mounting recess 210 are exchanged.

A user can mount and dismount the lamp housing 100 and the base 200 by operating the mounting portion 110 to rotate relative to the base 200, so that the mounting and dismounting processes are easy to operate and relatively time-saving and labor-saving. It is understandable that in other embodiments, the mounting portion 110 and the mounting recess 210 can also be set in other shapes, for example, the mounting portion 110 is of a conical structure, and the mounting recess 210 is of a conical recess corresponding to it.

Reference is made to FIG. 3 to FIG. 6 continuously, FIG. 4 is a partial enlarged view of the mounting portion 110 in area A in FIG. 3, and FIG. 6 is a partial enlarged view of the mounting recess 210 in area B in FIG. 5.

In an embodiment, the limiting structures 300 include first protrusions 310 and a second protrusion 320, the first protrusions 310 are formed on an outer wall of the mounting portion 110 and extend in a circumferential direction of the mounting portion 110, and the second protrusion 320 is formed on an inner wall of the mounting recess 210 and extends in an axial direction of the mounting recess 210. When the mounting portion 110 is inserted into the mounting recess 210 and rotated to a preset angle, a side edge of one of the first protrusions 310 abuts against a side edge of the second protrusion 320, the mounting portion 110 is rotated clockwise or counterclockwise in the circumferential direction thereof to be limited by the second protrusion 320, thereby preventing the mounting portion 110 from being jammed in the mounting recess 210 due to the excessively large rotation angle of the mounting portion 110, and preventing the situation that the lamp housing 100 cannot be detached from the base 200. In addition, the second protrusion 320 can limit the further rotation of the first protrusions 310, thereby avoiding or reducing the rotation or shaking of the lamp housing 100 relative to the base 200.

It should be noted that the “preset angle” in the full text of the present application is not limited to a specific value, the “preset angle” is determined by the positions of the limiting structures 300 provided in the tree lamp 10, and the positions of the limiting structures 300 can be set freely by a manufacturer according to requirements.

Specifically, FIG. 6 shows that the mounting recess 210 is further provided with third protrusions 330, and the third protrusions 330 extend in a circumferential direction of the mounting recess 210 and are higher than the second protrusion 320. That is, in a height direction of the mounting recess 210, the third protrusions 330 and the second protrusion 320 are staggered, and distances between the third protrusions 330 and a recess bottom are greater than a distance between the second protrusion 320 and the recess bottom. When the mounting portion 110 is inserted into the mounting recess 210 and rotated to the preset angle, upper edges of the first protrusions 310 abut against lower edges of the third protrusions 330, the movement of the mounting portion 110 in an axis direction is limited, and the lamp housing 100 cannot be separated from the base 200.

In this embodiment, the processes of mounting and detaching the lamp housing 100 from the base 200 are as follows:
the mounting portion 110 is inserted into the mounting recess 210, then the lamp housing 100 is rotated, when the lamp housing 100 drives the mounting portion 110 to rotate to the extent that the upper edges of the first protrusions 310 are in contact with the lower edges of the third protrusions 330, the movement of the mounting portion 110 in the axis direction is limited, the lamp housing 100 is continuously rotated, the lamp housing 100 drives the mounting portion 110 to rotate to the extent that the side edge of one of the first protrusions 310 abuts against the side edge of the second protrusion 320, the second protrusion 320 limits the further rotation of the mounting portion 110 in the circumferential direction, then the lamp housing 100 is rotated to the maximum angle, and the lamp housing 100 and the base 200 are in the relative fixed state. When the lamp housing 100 needs to be detached from the base 200, the lamp housing 100 is rotated in an opposite direction, the side edge of the first protrusion 310 is separated from the side edge of the second protrusion 320, the lamp housing 100 is continuously rotated to the extent that the upper edges of the first protrusions 310 are completely separated from the lower edges of the third protrusions 330, then the movement of the mounting portion 110 in the axis direction is not limited, and the lamp housing 100 can be detached from the base 200.

It is understandable that in the process of rotating the mounting portion 110 in a certain direction, when the mounting portion 110 is rotated to the extent that the upper edge of the first protrusion 310 is in contact with the lower edge of the second protrusion 320, the lamp housing 100 and the base 200 will be connected together, the mounting portion 110 is rotated continuously, when the upper edges of the first protrusions 310 are separated from the lower edges of the third protrusions 330, the axial limitation on the mounting portion 110 is removed, the lamp housing 100 can be detached from the base 200, thus there may be a mistake in the assembly process of the lamp housing 100 and the base 200, for example, if the upper edge of the first protrusion 310 is in contact with and then separated from the lower edge of the second protrusion 320 due to the fact that the mounting portion 110 is rotated by an excessively large angle, the lamp housing 100 cannot be successfully connected to the base 200; or if the contact area between the upper edge of the first protrusion 310 and the lower edge of the second protrusion 320 is small due to the fact that the mounting portion 110 is rotated by a relatively large angle, the lamp housing 100 and the base 200 are not firmly connected.

In this embodiment, the second protrusion 320 limits the maximum rotation angle of the mounting portion 110, so that when the lamp housing 100 is rotated to the extent that the side edge of the first protrusion 310 abuts against the side edge of the second protrusion 320 and the upper edges of the first protrusions 310 abut against the lower edges of the third protrusions 330, the excessively large rotation angle of the mounting portion 110 in the assembly process of the lamp housing 100 and the base 200 is avoided, and then the problem that the lamp housing 100 and the base 200 are not successfully connected or are not firmly connected is avoided.

Specifically, in an embodiment, the second protrusion 320 and one third protrusion 330 are of an integrated continuous structure and are in an L-shape as a whole, when the side edge of the first protrusion 310 abuts against the side edge of the second protrusion 320, the contact area between the upper edges of the first protrusions 310 and the lower edges of the third protrusions 330 is the largest, and the connection is the firmest. Besides, the second protrusion 320 and the third protrusion 330 can also be of split structures spaced apart from each other.

Further, there are a plurality of third protrusions 330, the plurality of third protrusions 330 are provided at intervals in the circumferential direction of the mounting recess 210, the number of the first protrusions 310 is equal to the number of the third protrusions 330, and positions of the first protrusions correspond to positions of the third protrusions on a one-to-one basis. When the lamp housing 100 is mounted on the base 200, the upper edge of each first protrusion 310 is in contact with the lower edge of the corresponding third protrusion 330. Thus, the stress uniformity of the mounting portion 110 can be improved, and the connection between the mounting portion 110 and the base 200 can be firmer.

In this embodiment, there is one second protrusion 320, that is, the effect of limiting the continuous rotation of the first protrusions 310 can be achieved by means of one second protrusion 320, and unnecessary second protrusions 320 are not needed. Of course, in other embodiments, the manufacturer can also provide a plurality of second protrusions 320 according to requirements, which is not limited in the present application.

Further, there may be three or four third protrusions 330, and the plurality of third protrusions 330 are distributed uniformly in the circumferential direction of the mounting recess 210. It is understandable that the stress uniformity of the mounting portion 110 is improved as the number of the third protrusions 330 increases. However, if there are too many third protrusions 330, the size of a gap between two adjacent third protrusions 330 is reduced, so that the difficulty in inserting the mounting portion 110 into the mounting recess 210 is increased. Therefore, in the present application, there are three or four third protrusions 330, so that the mounting portion 110 can have the good stress uniformity, and the mounting portion 110 can be relatively easily inserted into the mounting recess 210.

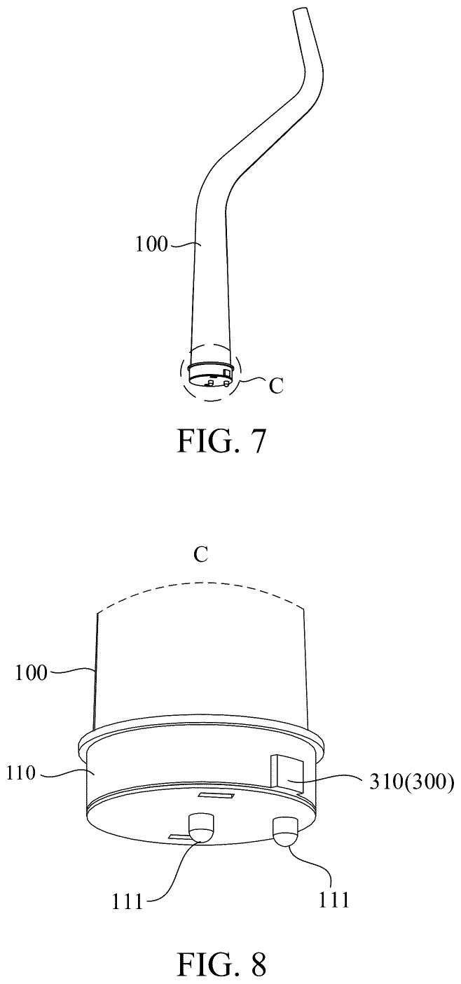

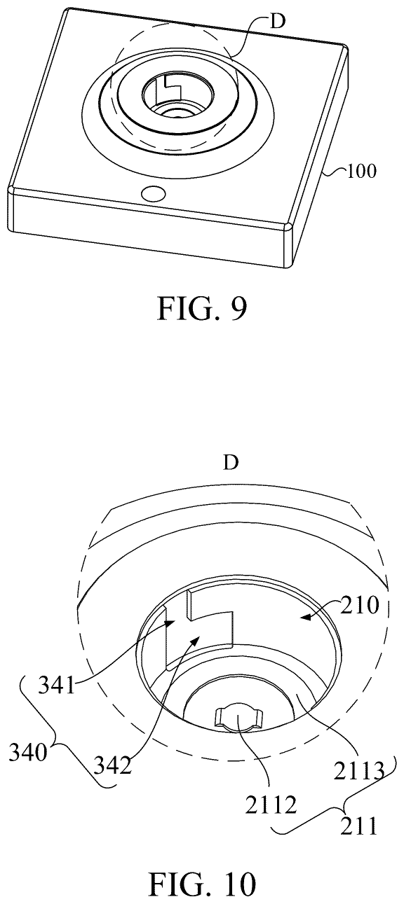

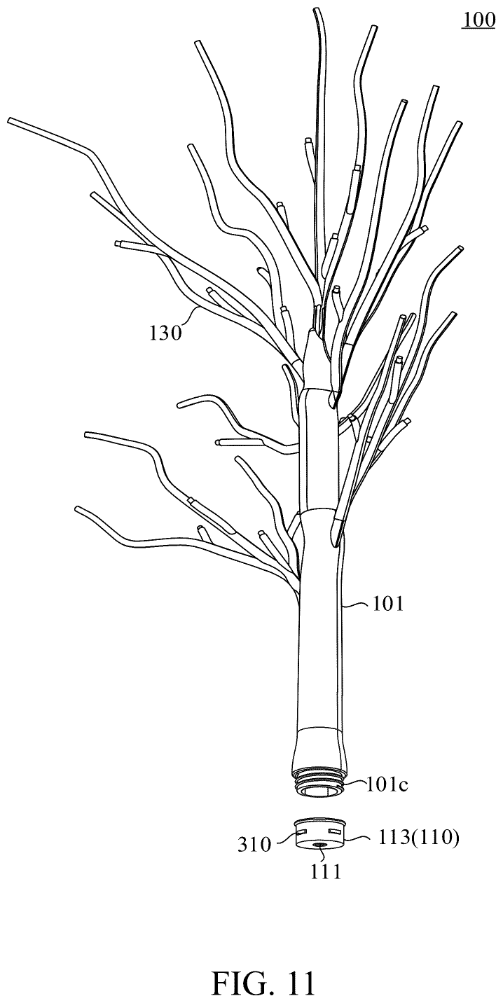

In another embodiment, reference is made to FIG. 7, FIG. 8, FIG. 9 and FIG. 10, FIG. 8 is a partial enlarged view of the mounting portion 110 in area C in FIG. 7, and FIG. 10 is a partial enlarged view of the mounting recess 210 in area D in FIG. 9.

The limiting structures 300 include the first protrusions 310 and limiting grooves 340, the first protrusions 310 are formed on a side wall of the mounting portion 110 and extend in an axial direction of the mounting portion 110, the limiting grooves 340 are L-shaped grooves and are formed in an inner wall of the mounting recess 210, and each of the limiting grooves 340 includes a first groove 341 extending in the axial direction of the mounting recess 210 and a second groove 342 extending in the circumferential direction of the mounting recess 210. In the process of mounting the lamp housing 100 on the base 200, the first protrusions 310 enter the first grooves 341 through openings of the first grooves 341, then enter the second grooves 342 and are rotated to the preset angle in the circumferential direction, the side edges of the first protrusions 310 abut against side walls of the second grooves 342 to limit the further rotation of the mounting portion 110, and meanwhile, the upper edges of the first protrusions 310 abut against upper edges of the second grooves 342 to limit the movement of the mounting portion 110 in the axial direction.

Specifically, there are two first protrusions 310 and two limiting grooves 340, the two limiting grooves 340 are distributed uniformly in the circumferential direction of the mounting recess 210, the two first protrusions 310 are distributed uniformly in the circumferential direction of the mounting portion 110, and the two first protrusions 310 correspond to the two limiting grooves 340 on a one-to-one basis. Thus, the stress uniformity of the mounting portion 110 can be improved, and the connection between the mounting portion 110 and the base 200 can be firmer.

In this embodiment, the processes of mounting and detaching the lamp housing 100 from the base 200 are as follows:
the first protrusions 310 of the mounting portion 110 are inserted into the first grooves 341 of the limiting grooves 340 in an aligned manner, then the lamp housing 100 is rotated, when the lamp housing 100 is rotated to the extent that the upper edges of the first protrusions 310 are in contact with upper groove walls of the second grooves 342, the movement of the mounting portion 110 in the axis direction is limited, the lamp housing 100 is continuously rotated, the lamp housing 100 drives the mounting portion 110 to rotate to the extent that the side edges of the first protrusions 310 abut against the side walls of the second grooves 342, the side walls of the second grooves 342 limit the further rotation of the mounting portion 110 in the circumferential direction, then the lamp housing 100 is rotated to the maximum angle, and the lamp housing 100 and the base 200 are in the relative fixed connection state. When the lamp housing 100 needs to be detached from the base 200, the lamp housing 100 is rotated in the opposite direction, the side edges of the first protrusions 310 are separated from the side walls of the second grooves 342, the lamp housing 100 is continuously rotated to the extent that the upper edges of the first protrusions 310 are completely separated from the upper edges of the second grooves 342, then the movement of the mounting portion 110 in the axis direction is not limited, and the lamp housing 100 can be detached from the base 200.

In conclusion, according to the tree lamp 10 in the embodiments of the present application, the first protrusions 310 are formed on the outer wall of the mounting portion 110, and the second protrusion 320 or the limiting grooves 340 are formed in the inner wall of the mounting recess 210, so that when the mounting portion 110 is inserted into the mounting recess 210 and rotated to the preset angle, the side edges of the first protrusions 310 abut against the side edge of the second protrusion 320 or the side walls of the limiting grooves 340 to limit the continuous rotation of the first protrusions 310, thereby limiting the continuous rotation of the mounting portion 110 relative to the base 200 in a certain direction, and limiting the rotation or shaking of the lamp housing 100 relative to the base 200.

It is understandable that the above embodiments are only for exemplary description of the limiting structures 300 and do not limit the limiting structures 300, and the tree lamp 10 can also be provided with the limiting structures 300 in other shapes to limit the rotation or shaking of the lamp housing 100 relative to the base 200.

For example, first magnetic members are provided on the mounting portion 110, and second magnetic members are provided at corresponding positions of the mounting recess 210, so that when the mounting portion 110 is rotated in the mounting recess 210 to the preset angle, the first magnetic members are connected to the second magnetic members in a magnetically attracted manner, thereby limiting the further rotation of the mounting portion 110, and then the reverse rotation of the mounting portion 110 is also limited by the magnetically attracted connection. Or the first protrusions 310 and the second protrusion 320 are all composed of magnetic members, when one of the first protrusion 310 abuts against the second protrusion 320, the second protrusion 320 limits the continuous rotation of the mounting portion 110, meanwhile, the reverse rotation of the mounting portion 110 is limited by the magnetically attracted connection of the first protrusion 310 and the second protrusion 320, and the user needs to apply a large force to rotate the mounting portion 110 in the opposite direction. That is, in some possible embodiments, the limiting structures 300 can limit the forward rotation and the reverse rotation of the mounting portion 110 at the same time.

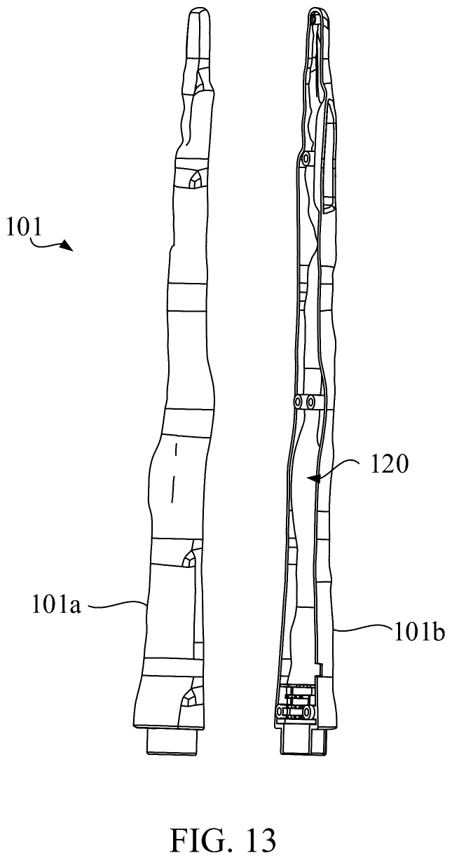

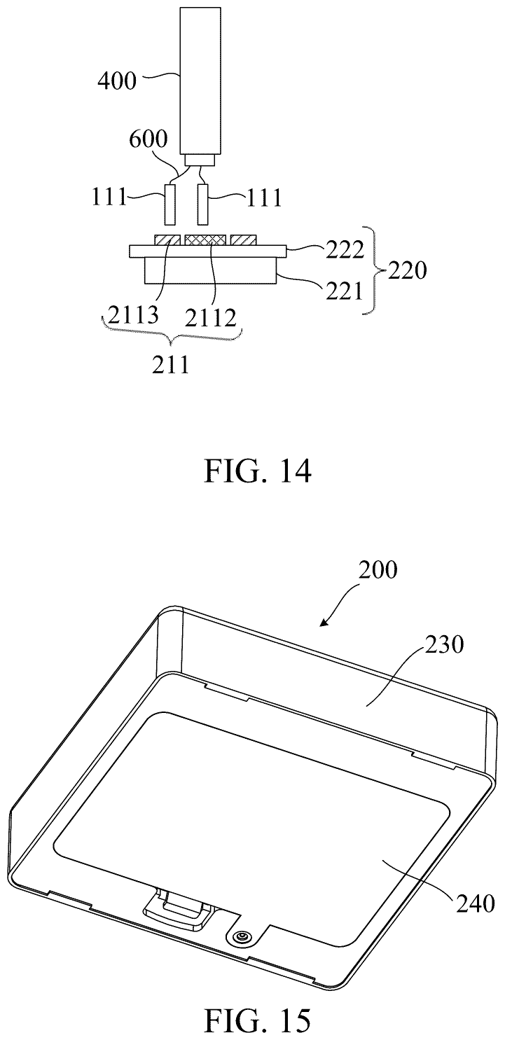

Reference is made to FIG. 11 to FIG. 14, in an embodiment, FIG. 13 and FIG. 14 show that an accommodating cavity 120 is provided inside the lamp housing 100; the tree lamp 10 further includes a light-emitting body 400 provided in the accommodating cavity 120; and the base 200 is provided with a power supply unit 220 for supplying power to the light-emitting body 400. The power supply unit 220 can be electrically connected to the light-emitting body 400 by means of wire 600 connection. Of course, in some possible embodiments, the light-emitting body 400 may be directly fixed to an outer surface of the lamp housing 100 instead of being provided in the accommodating cavity 120 inside the lamp housing 100.

Specifically, the mounting portion 110 is provided with a power connection contact 111 electrically connected to the light-emitting body 400, the mounting recess 210 is provided with an electrically-conductive structure 211 electrically connected to the power supply unit 220, and when the mounting portion 110 is mounted in the mounting recess 210, the power connection contact 111 is in contact with the electrically-conductive structure 211 to achieve electrical connection.

In the related technologies, the light-emitting body 400 is directly connected to the power supply unit 220 by means of the wire 600, so that it is difficult to completely separate the upper lamp housing 100 from the bottom base 200, and even if the lamp housing 100 is detached from the base 200, the two members will be restrained by the wire 600. Thus, it is inconvenient to maintain the base 200 separately.

However, in this embodiment, the mounting portion 110 is provided with the power connection contact 111, the mounting recess 210 is provided with the electrically-conductive structure 211, when the lamp housing 100 is mounted on the base 200, the light-emitting body 400 is electrically connected to the power supply unit 220 by means of the power connection contact 111 and the electrically-conductive structure 211, and the power supply unit 220 can provide power for the light-emitting body 400. When the lamp housing 100 is separated from the base 200, the power connection contact 111 is also separated from the electrically-conductive structure 211, so that the lamp housing 100 can be completely separated from the base 200 without being restrained, the convenience in separate maintenance of the base 200 can be improved, and it is more convenient to store and carry.

The light-emitting body 400 is an object that can emit light when being electrified, for example, an incandescent lamp and an LED lamp. The light-emitting body 400 can be electrically connected to the power connection contact 111 by means of the wire 600.

The power connection contact 111 and the electrically-conductive structure 211 are made of conductors, and for cost considerations, the conductors can be relatively common metal conductors, for example, copper, aluminum and nickel.

In an embodiment, reference is made to FIG. 3 to FIG. 6, the power connection contact 111 is provided inside the mounting portion 110, the bottom of the mounting portion 110 is provided with a first through hole 112, and the first through hole 112 is configured to expose the power connection contact 111. There is one power connection contact 111 that is located at the center of the mounting portion 110, the electrically-conductive structure 211 is an electrically-conductive column 2111 provided at the center of the mounting recess 210, and one end of the electrically-conductive column 2111 close to the power connection contact 111 is provided with an insertion hole 2111a allowing the power connection contact 111 to be inserted in.

In this embodiment, the power connection contact 111 is provided inside the mounting portion 110, that is, the power connection contact 111 is built into the mounting portion 110. On this basis, there is one power connection contact 111 that is located at the center of the mounting portion 110, the electrically-conductive structure 211 is the electrically-conductive column 2111 provided at the center of the mounting recess 210, and the power connection contact 111 and the electrically-conductive column 2111 are both located at the centers, so that in the process of rotating the mounting portion 110 relative to the mounting recess 210, the power connection contact 111 and the electrically-conductive structure 211 can always be kept opposite each other up and down, and the contact relationship between the power connection contact 111 and the electrically-conductive structure 211 will not be affected by the rotation angle of the mounting portion 110.

In another embodiment, reference is made to FIG. 7 to FIG. 10, the power connection contacts 111 are provided at the bottom of the mounting portion 110, there are two power connection contacts 111, and distances between the two power connection contacts 111 and the center of the mounting portion 110 are not equal. The electrically-conductive structure 211 is located on a bottom wall of the mounting recess 210, the electrically-conductive structure 211 includes a first electrically-conductive sheet 2112 and a second electrically-conductive sheet 2113, the first electrically-conductive sheet 2112 is a round electrically-conductive sheet, the second electrically-conductive sheet 2113 is an annular electrically-conductive sheet and surrounds the first electrically-conductive sheet 2112, and there is a gap between the first electrically-conductive sheet 2112 and the second electrically-conductive sheet 2113.

It is understandable that the two power connection contacts 111 are respectively configured to be in contact with the first electrically-conductive sheet 2112 and the second electrically-conductive sheet 2113, compared with the manner of providing only one power connection contact 111, such arrangement can reduce the impedance, thereby reducing the energy consumption of the tree lamp 10.

In addition, the distances between the two power connection contacts 111 and the center of the mounting portion 110 are not equal, the power connection contact 111 with the shorter distance from the center of the mounting portion 110 is configured to be in contact with the first electrically-conductive sheet 2112, and the power connection contact 111 with the longer distance from the center of the mounting portion 110 is configured to be in contact with the second electrically-conductive sheet 2113. The first electrically-conductive sheet 2112 and the second electrically-conductive sheet 2113 are the round electrically-conductive sheet and the annular electrically-conductive sheet respectively, so that in the process of rotating the mounting portion 110 relative to the mounting recess 210, the power connection contacts 111 and the corresponding electrically-conductive sheets can always be kept opposite each other up and down without staggering, and the contact relationship between the power connection contacts 111 and the corresponding electrically-conductive sheets will not be affected by the rotation angle of the mounting portion 110.

Further, one of the two power connection contacts 111 is located at the center of the mounting portion 110, and the other one can deviate from the center of the mounting portion 110, or the two power connection contacts 111 deviate from the center of the mounting portion 110. If one of the power connection contacts 111 is located at the center of the mounting portion 110, the area of the first electrically-conductive sheet 2112 can be set relatively small, which is more beneficial to reasonable arrangement of the electrically-conductive sheets in a limited space. If the two power connection contacts 111 deviate from the center of the mounting portion 110, the area of the first electrically-conductive sheet 2112 needs to be set relatively large, so that in a horizontal direction, the area of the first electrically-conductive sheet 2112 can cover the position of one of the power connection contacts 111.

The lamp housing 100 can be made of a resin material, for example, thermosetting resin, so that the lamp housing 100 has the good hardness and the good high-temperature resistance, and is free from the phenomenon of melting due to heating. FIG. 11 shows that the lamp housing 100 can be provided with a plurality of simulated branches 130, so that the lamp housing 100 is similar to a tree in shape.

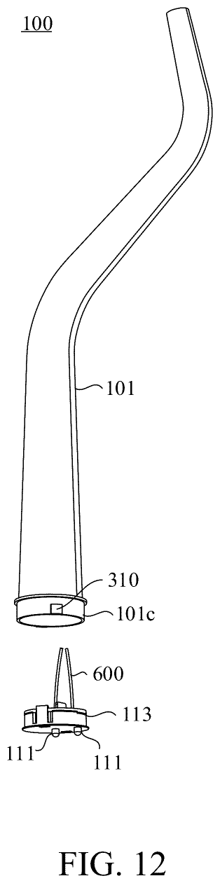

Reference is made to FIG. 11 to FIG. 12, the lamp housing 100 includes a housing body 101, the mounting portion 110 is detachably connected to a lower end of the housing body 101, the accommodating cavity 120 is located inside the housing body 101, the mounting portion 110 is of a sleeve structure 113, the power connection contact 111 is provided on the sleeve structure 113, the lower end of the housing body 101 is of a hollow cylindrical structure 101c, an inner cavity of the cylindrical structure 101c is in communication with the accommodating cavity 120 inside the housing body 101 or is deemed as a part of the accommodating cavity 120, and the sleeve structure 113 is detachably sleeved on an inner wall or an outer wall of the cylindrical structure 101c.

The light-emitting body 400 needs to be electrically connected to the power connection contact 111 by means of the wire 600 or other electrically-conductive manners, and during assembly of the lamp housing 100, the power connection contact 111 needs to be connected to the wire 600, so that the mounting portion 110 is configured to be detachably connected to the housing body 101, the wire 600 can be relatively easily connected, and the assembly is facilitated. In addition, the power connection contact 111 or the light-emitting body 400 is convenient to maintain or replace when being damaged.

Specifically, reference is made to FIG. 11, in this embodiment, the sleeve structure 113 is in threaded connection with the cylindrical structure 101c, and the sleeve structure 113 can be connected to or detached from the cylindrical structure 101c at the lower end of the housing body 101 in a rotating manner. An internal thread is formed on an inner wall of the sleeve structure 113, an external thread fitted with the internal thread is formed on the outer wall of the cylindrical structure 101c, the first protrusions 310 are located on an outer wall of the sleeve structure 113, and the sleeve structure 113 is sleeved on the outer wall of the cylindrical structure 101c. It is understandable that in other embodiments, an external thread can also be provided on an outer wall of a sleeve, an internal thread can be provided on the inner wall of the cylindrical structure 101c, the sleeve structure 113 is sleeved on the inner wall of the cylindrical structure 101c, then the first protrusions 310 are provided on the outer wall of the cylindrical structure 101c, and the cylindrical structure 101c and the sleeve structure 113 form the mounting portion 110.

In another embodiment, reference is made to FIG. 12, the sleeve structure 113 is provided with a snap-fitting block (not shown), at least a part of the snap-fitting block protrudes out of the outer wall of the sleeve structure 113, the inner wall of the cylindrical structure 101c is provided with a snap-fitting groove (not shown) fitted with the snap-fitting block, the sleeve structure 113 is sleeved on the inner wall of the cylindrical structure 101c, and at least a part of the snap-fitting block is embedded in the snap-fitting groove to limit the relative rotation of the sleeve structure 113 and the cylindrical structure 101c. It is understandable that in other embodiments, the snap-fitting block can be provided at the cylindrical structure 101c, the snap-fitting groove can be provided at the sleeve structure 113, and the positions of the first protrusions 310 are correspondingly adjusted.

It should be noted that in other embodiments, the sleeve structure 113 can also be detachably connected to the cylindrical structure 101c in other manners, including but not limited to interference fit and magnetically attracted connection.

In an embodiment, reference is made to FIG. 14, the power supply unit 220 includes a battery 221 and a circuit board 222, and the electrically-conductive structure 211 and the battery 221 are electrically connected to the circuit board 222. The circuit board 222 is provided with a circuit, and the battery 221 and the electrically-conductive structure 211 are connected into the circuit, so that the battery 221 can supply power to the light-emitting body 400. Of course, in other embodiments, power can also be supplied to the circuit board 222 and the light-emitting body 400 by means of an external power source.

In an embodiment, reference is made to FIG. 13, the housing body 101 includes a first housing body 101a and a second housing body 101b which are connected to each other, the first housing body 101a and the second housing body 101b can be produced and formed separately, before the first housing body 101a and the second housing body 101b are connected, the light-emitting body 400 can be assembled with the first housing body 101a or the second housing body 101b first, and then the first housing body 101a and the second housing body 101b are connected together by means of screw connection and gluing. Thus, when the light-emitting body 400 in the housing body 101 is damaged, the housing body 101 can be disassembled to replace the light-emitting body 400, and maintenance is facilitated.

Reference is continuously made to FIG. 1, the tree lamp 10 further includes a control switch 500, where the control switch 500 is electrically connected to the circuit board 222, and the control switch 500 is connected into the circuit where the electrically-conductive structure 211 and the battery 221 are located to control the connection or disconnection of the circuit. Thus, turning-on or turning-off of the light-emitting body 400 and the brightness of the light-emitting body 400 can be controlled by means of the control switch 500.

In some embodiments, as shown in FIG. 15, the base 200 includes an upper housing 230 and a lower cover plate 240, the lower cover plate 240 is detachably connected to the upper housing 230, the upper housing 230 and the lower cover plate 240 enclose a mounting cavity, and the power supply unit 220 is located in the mounting cavity. Specifically, the lower cover plate 240 can be connected to the upper housing 230 by means of screw connection and snap-fitting. Through such arrangement, the lower cover plate 240 can be detached from the upper housing 230, thereby facilitating maintenance or replacement of the power supply unit 220.

In the description of this embodiment, unless otherwise specified, “a plurality of” means two or more. The above content is only the particular embodiments of the present application, but the scope of protection of the present application is not limited to these embodiments. Any modification or replacement within the scope of technologies disclosed in the present application should be included in the scope of protection of the present application. Therefore, the scope of protection of the present application should be subject to the scope of protection of the claims.

1. A tree lamp, comprising:
a lamp housing, wherein the lamp housing is configured to have a tree shape, and a lower end of the lamp housing is provided with a mounting portion; and
a base, wherein a top surface of the base is provided with a mounting recess fitted with the mounting portion, and the mounting portion is detachably mounted in the mounting recess; and
the mounting portion and/or the mounting recess are/is provided with limiting structures, and when the mounting portion is mounted in the mounting recess, the limiting structures abut against the mounting portion or the mounting recess so as to limit rotation of the mounting portion relative to the mounting recess in at least one direction.

2. The tree lamp according to claim 1, wherein the mounting portion is of a columnar structure, the mounting recess is a round recess, and the mounting portion is capable of being connected to the base in a manner of rotating relative to the mounting recess.

3. The tree lamp according to claim 2, wherein the limiting structures comprise first protrusions and a second protrusion, the first protrusions are formed on an outer wall of the mounting portion and extend in a circumferential direction of the mounting portion, and the second protrusion is formed on an inner wall of the mounting recess and extends in an axial direction of the mounting recess; and
when the mounting portion is inserted into the mounting recess and rotated to a preset angle, a side edge of one of the first protrusions abuts against a side edge of the second protrusion.

4. The tree lamp according to claim 3, wherein the mounting recess is further provided with third protrusions, and the third protrusions extend in a circumferential direction of the mounting recess and are higher than the second protrusion; and
when the mounting portion is inserted into the mounting recess and rotated to the preset angle, upper edges of the first protrusions abut against lower edges of the third protrusions.

5. The tree lamp according to claim 4, wherein there are a plurality of third protrusions, the plurality of third protrusions are provided at intervals in the circumferential direction of the mounting recess, the number of the first protrusions is equal to the number of the third protrusions, and positions of the first protrusions are fitted with positions of the third protrusions.

6. The tree lamp according to claim 5, wherein there are three or four third protrusions, and the plurality of third protrusions are distributed uniformly in the circumferential direction of the mounting recess.

7. The tree lamp according to claim 6, wherein there is one second protrusion.

8. The tree lamp according to claim 2, wherein the limiting structures comprise first protrusions and limiting grooves, the first protrusions are formed on a side wall of the mounting portion and extend in an axial direction of the mounting portion, the limiting grooves are L-shaped grooves and are formed in an inner wall of the mounting recess, and each of the limiting grooves comprises a first groove extending in an axial direction of the mounting recess and a second groove extending in a circumferential direction of the mounting recess; and
in a process of mounting the lamp housing on the base, when the first protrusions are inserted into the first grooves through openings of the first grooves, then enter the second grooves and are rotated to a preset angle in the circumferential direction, side edges of the first protrusions abut against side walls of the second grooves.

9. The tree lamp according to claim 8, wherein there are two limiting grooves and two first protrusions, the two limiting grooves are distributed uniformly in the circumferential direction of the mounting recess, the two first protrusions are distributed uniformly in a circumferential direction of the mounting portion, and positions of the first protrusions are fitted with positions of the limiting grooves.

10. The tree lamp according to claim 1, wherein an accommodating cavity is provided inside the lamp housing; the tree lamp further comprises a light-emitting body provided in the accommodating cavity; and a power supply unit for supplying power to the light-emitting body is provided inside the base.

11. The tree lamp according to claim 10, wherein the mounting portion is provided with a power connection contact electrically connected to the light-emitting body, the mounting recess is provided with an electrically-conductive structure electrically connected to the power supply unit, and when the mounting portion is mounted in the mounting recess, the power connection contact is in contact with the electrically-conductive structure.

12. The tree lamp according to claim 11, wherein the power connection contact is provided inside the mounting portion, the bottom of the mounting portion is provided with a first through hole for exposing the power connection contact, and there is one power connection contact that is located at the center of the mounting portion; and
the electrically-conductive structure is an electrically-conductive column provided at the center of the mounting recess, and one end of the electrically-conductive column close to the power connection contact is provided with an insertion hole allowing the power connection contact to be inserted in.

13. The tree lamp according to claim 11, wherein the power connection contacts are provided at the bottom of the mounting portion, there are two power connection contacts, and distances between the two power connection contacts and the center of the mounting portion are not equal;
the electrically-conductive structure is located on a bottom wall of the mounting recess, the electrically-conductive structure comprises a first electrically-conductive sheet and a second electrically-conductive sheet, and the first electrically-conductive sheet and the second electrically-conductive sheet are configured to be in contact with the different power connection contacts; and the first electrically-conductive sheet is a round electrically-conductive sheet, the second electrically-conductive sheet is an annular electrically-conductive sheet and surrounds the first electrically-conductive sheet, and there is a gap between the first electrically-conductive sheet and the second electrically-conductive sheet.

14. The tree lamp according to claim 13, wherein one of the two power connection contacts is located at the center of the mounting portion, and the other one deviates from the center of the mounting portion, or
the two power connection contacts deviate from the center of the mounting portion.

15. The tree lamp according to claim 11, wherein the lamp housing comprises a housing body, the mounting portion is detachably connected to a lower end of the housing body, the accommodating cavity is located inside the housing body, the mounting portion is of a sleeve structure, the power connection contact is provided on the sleeve structure, the lower end of the housing body is of a hollow cylindrical structure, and the sleeve structure is detachably sleeved on an inner wall or an outer wall of the cylindrical structure.

16. The tree lamp according to claim 15, wherein the sleeve structure is in threaded connection with the cylindrical structure, an internal thread is formed on an inner wall of the sleeve structure, and an external thread fitted with the internal thread is formed on the outer wall of the cylindrical structure.

17. The tree lamp according to claim 15, wherein the sleeve structure is provided with a snap-fitting block, at least a part of the snap-fitting block protrudes out of an outer wall of the sleeve structure, the inner wall of the cylindrical structure is provided with a snap-fitting groove fitted with the snap-fitting block, the sleeve structure is sleeved on the inner wall of the cylindrical structure, and the snap-fitting block is embedded in the snap-fitting groove.

18. The tree lamp according to claim 11, wherein the power supply unit comprises a battery and a circuit board, and the electrically-conductive structure and the battery are electrically connected to the circuit board.

19. The tree lamp according to claim 18, further comprising a control switch, wherein the control switch is electrically connected to the circuit board.

20. The tree lamp according to claim 11, wherein the base comprises an upper housing and a lower cover plate, the lower cover plate is detachably connected to the upper housing, the upper housing and the lower cover plate enclose a mounting cavity, and the power supply unit is located in the mounting cavity.
